(19) United States
(12) Patent Application Publication
(10) Pub. No.: US 2025/0110845 A1
(43) Pub. Date: Apr. 3, 2025

(54) TASK MANAGEMENT SYSTEM

(71) Applicant: Hitachi, Ltd., Tokyo (JP)

(72) Inventor: Shusaku MIWA, Tokyo (JP)

(73) Assignee: Hitachi, Ltd., Tokyo (JP)

(21) Appl. No.: 18/599,634

(22) Filed: Mar. 8, 2024

(30) Foreign Application Priority Data
Sep. 29, 2023 (JP) 2023-169861

(51) Int. Cl. G06F 11/30

(52) U.S. Cl. CPC G06F 11/3017; G06F 11/3051

(57) ABSTRACT

A task management system is configured to store a consumption resource amount transition prediction of a resource consumed by tasks, and effective resource amount information for managing an effective resource amount indicating a total resource amount that is providable from the resource. The task management system is configured to, for the resource consumed by each of the tasks, compare a consumption resource amount prediction obtained from the consumption resource amount transition prediction with a current consumption resource amount, determine that the effective resource amount of the resource is decreased when a predetermined condition including that the current consumption resource amount is smaller than the consumption resource amount prediction is satisfied, estimate a decrease amount of the effective resource amount based on a difference between the current consumption resource amount and the consumption resource amount prediction, and determine an influence on task execution based on the decrease amount.

### CLAIM OF PRIORITY

The present application claims priority from Japanese patent application JP 2023-169861 filed on Sep. 29, 2023, the content of which is hereby incorporated by reference into this application.

### BACKGROUND OF THE INVENTION

### 1. Field of the Invention

The present invention relates to task management.

### 2. Description of Related Art

As a background art of this technical field, there is JP2008-3736A. This document discloses the following matters (see abstract). “In a computer center that provides a job execution computer to a user, when the user wants to execute a job exceeding a computer resource amount, the computer resource amount is limited, all tasks cannot be executed, resulting in a delay in business. An object of the invention is to avoid the business delay by preventing a shortage of computer resources.” “Job execution prediction is performed based on a job execution schedule applied by the user and an actual job execution record, and a warning is issued when the job execution prediction is predicted to exceed the computer resource during the number of days required to add a computer resource in the future”.

### CITATION LIST

### Patent Literature

Patent Literature 1: JP2008-3736A

### SUMMARY OF THE INVENTION

By predicting a resource amount consumed by a task before the task is executed, it is possible to allocate an appropriate resource to the task. However, there is a case in which a total resource amount (effective resource amount) which may be given to (consumed by) the task and an actual consumption resource amount of a task transition differently than an assumption during the execution of the task or before the task is executed according to the schedule. For example, disturbances such as a maintenance process for a system other than the task, performance degradation caused by a network delay or a software failure, and a degeneration operation caused by a hardware failure or the software failure may influence the task-related resource amount.

When the disturbance occurs, it is necessary to predict whether a target completion time of the task can be kept due to an occurrence of a resource shortage during a task execution time. In order to predict the completion time of the task, it is important to more accurately predict a decrease in an effective resource amount caused by an unknown disturbance and a consumption resource amount before completion of task execution.

A typical example according to the invention is a task management system that manages a plurality of tasks executed by a target system, the task management system including:
a processor; and
a memory, in which
the memory is configured to store
   a consumption resource amount transition prediction of a resource consumed by the plurality of tasks, and
   effective resource amount information for managing an effective resource amount indicating a total resource amount that is providable from the resource, and
the processor is configured to, for the resource consumed by each of the plurality of tasks,
   compare a consumption resource amount prediction obtained from the consumption resource amount transition prediction with a current consumption resource amount,
   determine that the effective resource amount of the resource is decreased when a predetermined condition including that the current consumption resource amount is smaller than the consumption resource amount prediction is satisfied,
   estimate a decrease amount of the effective resource amount based on a difference between the current consumption resource amount and the consumption resource amount prediction, and
determine an influence on task execution based on the decrease amount.

According to an aspect of the invention, a completion time of a task can be predicted more accurately.

### BRIEF DESCRIPTION OF THE DRAWINGS

FIG. 1 shows a configuration example of a computer system according to an embodiment of the present specification;

FIG. 2 shows an example of resources provided by a server;

FIG. 3 shows an example of resources provided by a storage system;

FIG. 4 shows a configuration example of a task schedule table;

FIG. 5 shows a configuration example of a task table;

FIG. 6 shows a configuration example of a current system effective-resource amount table;

FIG. 7 shows a configuration example of a deemed system effective-resource decrease-amount table;

FIG. 8 shows a configuration example of a deemed each-task effective-resource decrease-amount table;

FIG. 9 shows a configuration example of a current system consumption-resource amount table;

FIG. 10 shows a configuration example of a system consumption-resource amount transition prediction table;

FIG. 11 shows a configuration example of an each-task consumption-resource amount transition prediction table;

FIG. 12 shows a configuration example of an each-trigger resource amount influence definition table;

FIG. 13 shows a flowchart of a process of updating a system consumption resource amount;

FIG. 14 shows a flowchart of a task registration process;

FIG. 15A shows a flowchart of a task execution process;

FIG. 15B shows the flowchart of the task execution process;

FIG. 16 shows a flowchart of a process of calculating a system available-resource amount transition prediction;

FIG. 17A shows a flowchart of a process of detecting an occurrence of a non-assumed disturbance and determining an influence degree;

FIG. 17B shows the flowchart of the process of detecting the occurrence of the non-assumed disturbance and determining the influence degree;

FIG. 18 shows a flowchart of a process of calculating a deemed effective-resource decrease amount at the time of detecting a resource consumable disturbance;

FIG. 19 shows a flowchart of a process of calculating a deemed effective-resource decrease amount at the time of detecting a resource non-consumable disturbance;

FIG. 20 shows a flowchart of a process of calculating a deemed system effective-resource decrease amount;

FIG. 21 shows a flowchart of a process of calculating an actual effective-resource amount and determining an influence degree on a task;

FIG. 22 shows a flowchart of a resource shortage influence determination process of the task;

FIG. 23 shows a flowchart of a process of detecting an assumed disturbance and determining an influence degree;

FIG. 24A shows an example of an image of a task schedule at the time of task registration;

FIG. 24B shows an example of a display image of the task schedule and an alert when the task fails to start; and

FIG. 24C shows an example of a display image of the task schedule and the alert when a task target completion time is detected to not be reached due to a disturbance.

### DESCRIPTION OF EMBODIMENTS

In the following embodiments, if necessary for the convenience, the description will be made by being divided into a plurality of sections or embodiments, but unless otherwise stated, those are not unrelated to one another, and the one is a modification of a portion or all of the other, detail, supplementary explanation, and the like. Further, in the following embodiments, in the case where the number of elements (including the number, numerical values, amounts, ranges, or the like) is referred to, particularly unless explicitly stated and unless clearly limited to a specific number in principle, the number of elements is not limited to a specific number, and it may be a specific number or more and the specific number or less.

A computer system can be constituted by one computer or a plurality of computers that can communicate with each other. A computer device, the computer system, or a computing resource group includes one or more interface devices (including a communication device and an input and output device, for example), one or more storage devices (including a memory (main storage) and an auxiliary storage device, for example), and one or more processors.

When a function is implemented by a program being executed by a processor, the function may be at least a part of the processor as specified processing is performed using a storage device and/or an interface device as appropriate. The processing described with a function as a subject may be processing performed by a processor or a system including the processor.

The program may be installed from a program source. The program source may be, for example, a program distribution computer or a computer-readable storage medium (for example, a computer-readable non-transitory storage medium). The description of the functions is an example, and a plurality of functions may be integrated into one function, or one function may be divided into a plurality of functions.

Task management according to an embodiment in the present specification will be described below. A management system executes a plurality of tasks using other devices and manages the plurality of tasks. The devices used for executing the task may include a processing server (also simply referred to as a server), a storage system, a network, and the like. A configuration of a management target system is not particularly limited.

Each device includes resources of which usage can be measured, such as a CPU (processor), a memory (main storage), an auxiliary storage device, a network, or a communication interface. The resources may include hardware resources and software resources. For example, a CPU or a memory of a virtual machine may be in a resource considered for task execution.

The management system observes a resource consumption amount of each unit of each device at any time. As described above, the device is, for example, a server or a storage system, and the unit is, for example, a CPU or a memory. A resource amount of each unit of each device managed by the management system is described as follows.

An effective resource amount of each unit is a maximum resource amount of the unit which can be provided to the task by the management system. An available resource amount is a resource amount in the effective resource amount, which can be additionally given to the task by the management system. A consumption resource amount is a resource amount given to the task by the management system. The three resource amounts satisfy the following relational expression.

Effective resource amount=available resource amount+consumption resource amount

Therefore, the effective resource amount is represented by the available resource amount and the consumption resource amount, and the available resource amount is represented by the effective resource amount and the consumption resource amount. The task consumes resources of the system to perform a necessary process. The task has a restriction on an execution time thereof. For example, there are a startable time and a target completion time, and the task is required to be executed after the startable time and to be completed by the target completion time. The plurality of tasks can be simultaneously executed. The management system is required to schedule the plurality of tasks to avoid a resource shortage for the tasks and to complete the tasks by target completion times.

A state in which an available resource amount of a certain resource becomes 0 and the consumption resource amount required by any task is insufficient is a resource shortage state for that task. If the resource is insufficient, a task execution time is extended, which causes the target completion time not to be kept. Therefore, when an occurrence of the resource shortage is estimated, a countermeasure against the resource shortage is required.

The management system according to an embodiment in the present specification holds the schedule of the task executed by the management target system and starts the task according to the schedule. The user or the management system determines in advance an optimal schedule that takes into account the resource in the system, thereby avoiding the resource shortage and completing the task within a target time.

During or before the execution of the task, the effective resource amount may transition differently from expected. The available resource amount and the consumption resource amount also change due to an unexpected change in the effective resource amount. A decrease in the effective resource amount can influence a task completion target time, and is therefore referred to as a disturbance to the execution of the task. Examples of the disturbance include a maintenance process (firmware update, virus scan, and the like) for the system other than the task, performance degradation caused by a network delay or a software failure, and degeneration operation caused by a hardware failure or the software failure.

In a case in which the task execution is started or continued in a state in which the effective resource amount is decreased due to an occurrence of the disturbance, that is, the available resource amount is decreased, the resource may immediately become insufficient. Alternatively, when the consumption resource amount of the task increases, the resource shortage may occur. As a result of the resource shortage, the task may not be completed by the target completion time.

The management system according to an embodiment of the present specification estimates occurrences of various disturbances including disturbances that cannot be predicted in advance, and a resulting change in the available resource amount, and determines an influence of the change on the task execution. Accordingly, it is possible to reduce a possibility that the task is not appropriately executed. For example, based on the estimated change in the available resource amount, the management system calculates a possibility that the consumption resource amount required by the task currently being executed or to be executed will be insufficient or that the target completion time will be exceeded. As a result of the calculation, when the resource shortage is found or the target completion time is to be exceeded, an alert of occurrence of a problem is presented to the user.

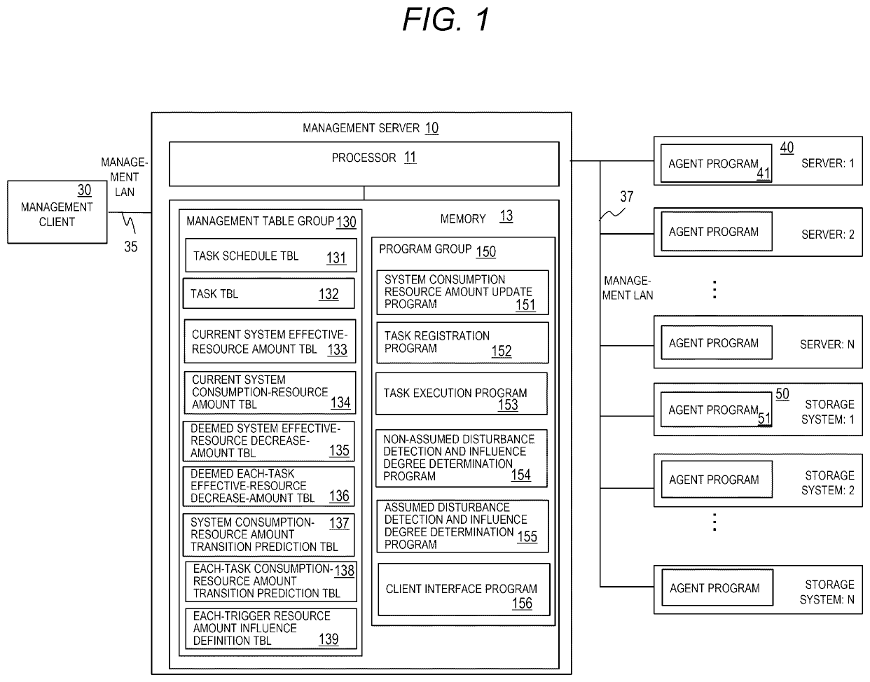

Hereinafter, a more specific configuration example of the present disclosure will be described. FIG. 1 shows a configuration example of the computer system according to an embodiment of the present specification. The computer system includes a management server 10, a management client 30, and constructing devices of the management target system. The management target devices include a plurality of processing servers 40 (also simply referred to as servers) and a plurality of storage systems 50. The management server 10 communicates with the management client 30 via a management LAN 35, and communicates with the management target devices 40 and 50 via the management LAN 37. The types of these networks are free. The management server 10 and the management client 30 are management systems. The management client 30 may be omitted, and a plurality of management servers may execute processes to be described below.

In FIG. 1, one of a plurality of servers is indicated by a reference numeral 40 as an example, and one of a plurality of storage systems is indicated by a reference numeral 50 as an example. The server 40 executes an agent program 41. The agent program 41 provides the management server 10 with information on a resource of the server 40, and executes a task in the server 40 in response to an instruction from the management server 10 or controls execution of the task.

The storage system 50 executes an agent program 51. The agent program 51 provides the management server 10 with information on a resource of the storage system 50, and executes a task in the storage system 50 in response to the instruction from the management server 10 or controls execution of the task.

The management server 10 grasps statuses of the resources of the server 40 and the storage system 50 via the agent programs 41 and 51, and manages and controls the tasks using these resources. The management server 10 includes a processor 11 and a memory 13 as a main storage device, and the processor 11 executes a program group 150 stored in the memory 13.

The management server 10 further includes a plurality of disks (also referred to as storage drives) as auxiliary storage devices and a communication interface that communicates with other devices via a network. These are omitted in FIG. 1.

The memory 13 is, for example, a DRAM that is a volatile storage device, and the disk is, for example, a solid state drive (SSD) or a hard disk drive (HDD) that is a nonvolatile storage device. The number of components of the management server 10 is not particularly limited, and other components such as an input device and an output device may be provided. Examples of the input device include a mouse and a keyboard, and examples of the output device include a display device and a printer.

A program (instruction code) executed by the processor 11 and information used by the program are stored in, for example, the disk, and loaded into the memory 13. The processor 11 implements a predetermined function by executing the program stored in the memory 13 (operating according to an instruction in the program). The processor 11 may include one or more processor units or processor cores.

The management client 30 is a device for a user to communicate with the management server 10, and transmits information to the management server 10 or receives the information from the management server 10. The management server 10 presents the information to the user via the management client 30. The management client 30 may have a configuration of a general PC.

For example, as described for the management server 10, the management client 30 may include a processor, a memory as a main storage device, a disk as an auxiliary storage device, a communication interface, an input device, and an output device. Examples of the input device include a mouse and a keyboard, and examples of the output device include a display device and a printer.

The memory 13 of the management server 10 stores a management table group 130. The management table group 130 includes a task schedule table (TBL) 131, a task table 132, a current system effective-resource amount table 133, a current system consumption-resource amount table 134, a deemed system effective-resource decrease-amount table 135, a deemed each-task effective-resource decrease-amount table 136, a system consumption-resource amount transition prediction table 137, an each-task consumption-resource amount transition prediction table 138, and an each-trigger resource amount influence definition table 139. Details thereof will be described later.

The memory 13 of the management server 10 stores the program group 150. The program group 150 includes a system consumption resource amount update program 151, a task registration program 152, a task execution program 153, a non-assumed disturbance detection and influence degree determination program 154, an assumed disturbance detection and influence degree determination program 155, and a client interface program 156.

The system consumption resource amount update program 151 updates information on a consumption resource amount in the management target system. The task registration program 152 registers information of a task in the management table group 130. The task execution program 153 instructs an agent program of each device to execute the task based on the information of the task. Each device executes the instruction.

The non-assumed disturbance detection and influence degree determination program 154 periodically monitors execution states of each device and the task, and performs disturbance detection and influence degree determination. The non-assumed disturbance detection and influence degree determination program 154 detects non-completion of the task before a target completion time of the task, and issues an alert to the management client 30 via the client interface program 156. Further, through the client interface program 156, a resource that is a source of the disturbance and a prediction completion time of the task are presented to the management client 30.

The assumed disturbance detection and influence degree determination program 155 performs disturbance detection and influence degree determination when a disturbance assumed and defined in advance occurs. The assumed disturbance detection and influence degree determination program 155 detects the non-completion of the task before the target completion time of the task, and issues an alert to the management client 30 via the client interface program 156. Further, through the client interface program 156, a resource that is a source of the disturbance and the prediction completion time of the task are presented to the management client 30.

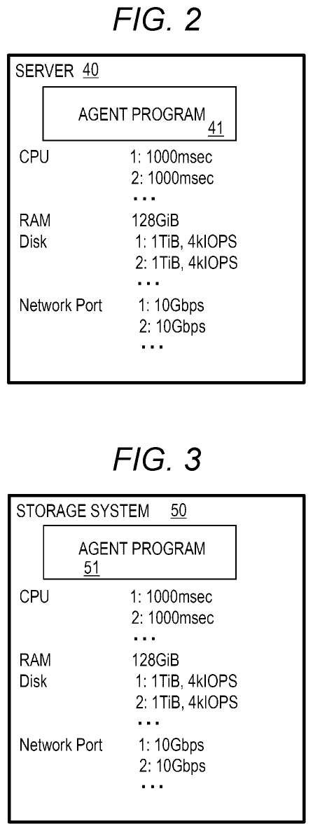

FIGS. 2 and 3 illustrate examples of the resources in the management target devices used for executing the task. The server and the storage system have the resources such as CPUs and a RAM that can be used for executing the task. Examples of the resources of each device will be described below.

FIG. 2 illustrates an example of the resources provided by the server 40. Types thereof include a CPU, a RAM, a disk, and a network port. The disk is an auxiliary storage device, for example, an HDD or an SSD. Further, the number of elements of each resource type is one or more.

The CPU treats a consumption time per second in msec, and assumes that an effective resource amount is 1,000 msec per core. A time used for a specific process is the consumption resource amount. A capacity of the RAM is a resource amount. A capacity of the disk is a resource amount. Further, the number of responses per second (IOPS) is a resource amount. Accordingly, a response delay can be converted into a resource amount. In the Network Port, bandwidth is a resource amount. Further, the number of responses per second (IOPS) is a resource amount. Accordingly, the response delay can be converted into a resource amount. Thus, each unit has one or more types of resource amounts.

FIG. 3 shows an example of resources provided by the storage system 50. Types thereof may include a specific resource (not shown in FIG. 3) such as a queue in addition to the same resource types as the server 40, specifically, the CPU, the RAM, the disk, and the network port.

Effective resource amounts of the CPU and the RAM among the effective resources can be basically used up. On the other hand, effective resource amounts such as bandwidth of a network, IOPS, and the like may not be used up due to various factors such as communication route and a status of a communication destination. Such a resource is also referred to as a resource having an effective-resource hiding and reducing factor.

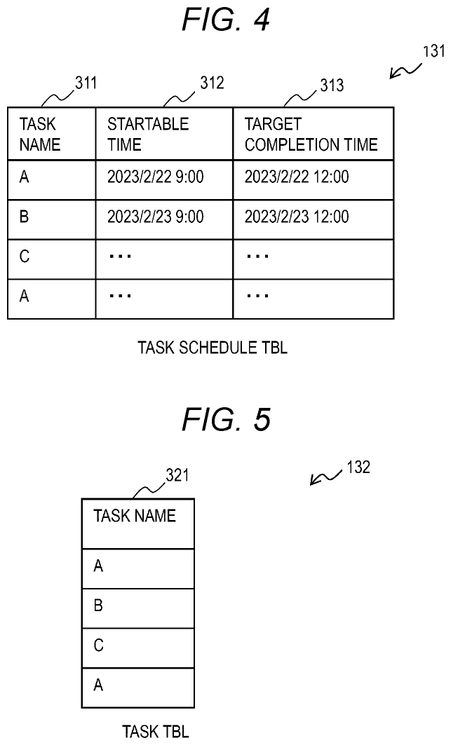

FIG. 4 shows a configuration example of the task schedule table 131. The task schedule table 131 manages a task execution schedule, and is created and updated by the task registration program 152. In the configuration example of FIG. 4, the task schedule table 131 includes a task name column 311, a startable time column 312, and a target completion time column 313.

The task name column 311 shows a name for identifying the task. The startable time column 312 shows a time at which the task execution can be started. The task execution is possible on and after the day. The target completion time column 313 indicates a target time at which the task is completed. The time is expressed as a date and a time within a day.

FIG. 5 shows a configuration example of the task table 132. The task table 132 manages a method for calculating a size of the task. The task table 132 is created and updated by the task registration program 152 according to designation form the user. In the configuration example of FIG. 5, the task table 132 includes a task name column 321. The task name column 321 shows a name for identifying the task.

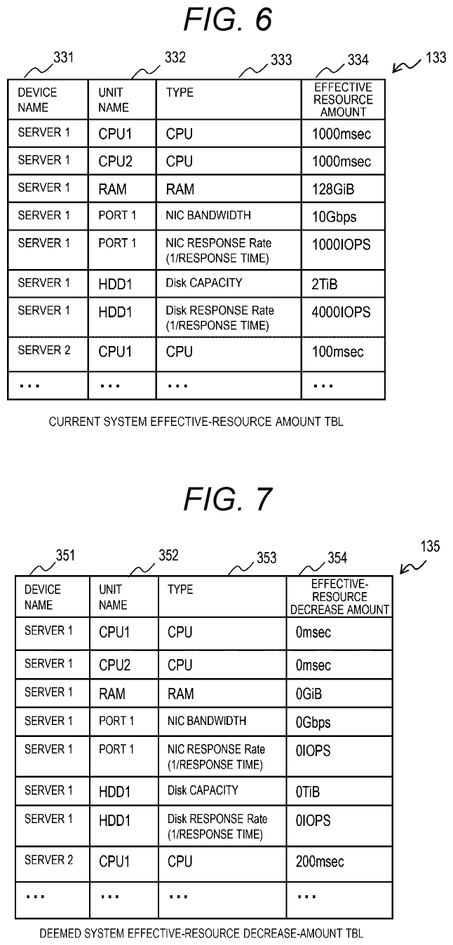

FIG. 6 shows a configuration example of the current system effective-resource amount table 133. The current system effective-resource amount table 133 manages a current effective-resource amount of each portion of each device in the system. Information on the current effective-resource amount can be acquired from each device by the agent programs 41 and 51.

In the configuration example of FIG. 6, the current system effective-resource amount table 133 includes a device name column 331, a unit name column 332, a type column 333, and an effective resource amount column 334. Each record indicates an effective resource amount of one resource type of one unit in one device. As described above, one or more resource types are defined for each unit.

The device name column 331 indicates a name of the device to identify the device, and the unit name column 332 indicates a name of the unit to identify the unit in each device. The type column 333 indicates a type of a consumption resource of the unit. The effective resource amount column 334 indicates the current effective-resource amount.

FIG. 7 shows a configuration example of the deemed system effective-resource decrease-amount table 135. The deemed system effective-resource decrease-amount table 135 manages an estimated decrease amount of the effective resource amount in the system due to the disturbance. The disturbance that influences the resource amount in the system includes a disturbance that is assumed (specifiable) in advance and a disturbance that is not assumed (unspecified) in advance.

In the configuration example shown in FIG. 7, the deemed system effective-resource decrease-amount table 135 includes a device name column 351, a unit name column 352, a type column 353, and an effective-resource decrease amount column 354. The device name column 351 indicates a name of the device to identify the device, and the unit name column 352 indicates a name of the unit to identify the unit in each device. The type column 353 indicates a type of the consumption resource of the unit. The effective-resource decrease amount column 354 indicates an effective-resource decrease amount caused an estimated disturbance.

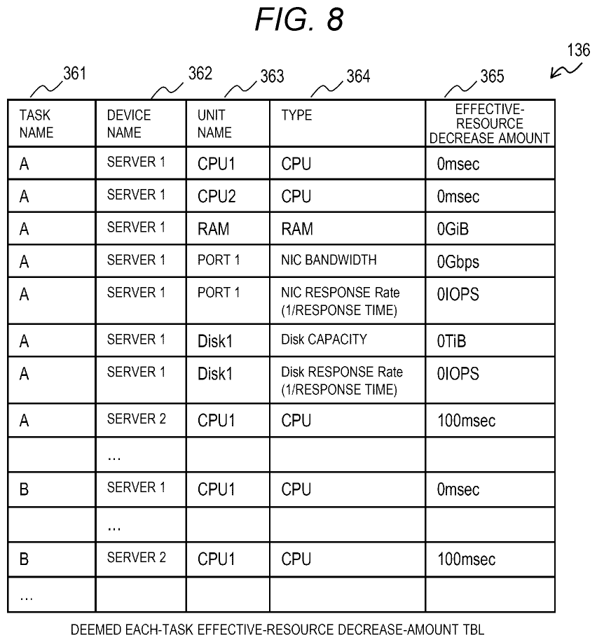

FIG. 8 shows a configuration example of the deemed each-task effective-resource decrease-amount table 136. The deemed each-task effective-resource decrease-amount table 136 manages an estimated decrease amount for each task in the effective resource amount in the system due to the disturbance. The disturbance that influences the resource amount in the system includes the disturbance that is assumed (specifiable) in advance and the disturbance that is non-assumed (unspecified) in advance.

In the configuration example shown in FIG. 8, the deemed each-task effective-resource decrease-amount table 136 includes a task name 361, a device name column 362, a unit name column 363, a type column 364, and an effective-resource decrease amount column 365. The task name 361 indicates a name for identifying the task. The device name column 362 indicates a name of the device to identify the device, and the unit name column 363 indicates a name of the unit to identify the unit in each device. The type column 364 indicates a type of the consumption resource of the unit. The effective-resource decrease amount column 365 indicates the effective-resource decrease amount for the task caused by the estimated disturbance.

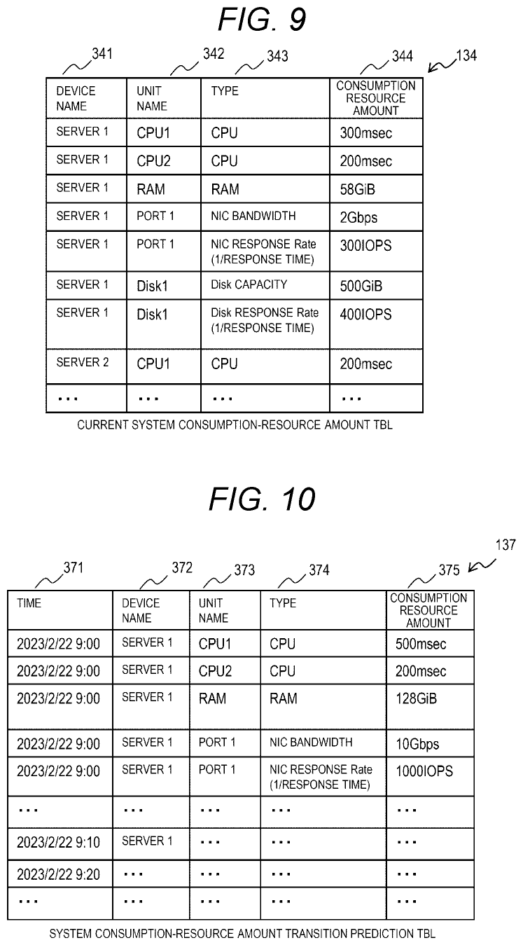

FIG. 9 shows a configuration example of the current system consumption-resource amount table 134. The current system consumption-resource 134 manages amount table a current consumption resource amount of each unit of each device in the system. Information on the current consumption resource amount can be acquired from each device by the agent programs 41 and 51.

In the configuration example shown in FIG. 9, the current system consumption-resource amount table 134 includes a device name column 341, a unit name column 342, a type column 343, and a consumption resource amount column 344. Each record indicates the current consumption resource amount of one resource type of one unit in one device. The device name column 341 indicates a name of the device to identify the device, and the unit name column 342 indicates a name of the unit to identify the unit in each device. The type column 343 indicates a type of the consumption resource of the unit. The consumption resource amount column 344 indicates the current consumption resource amount.

FIG. 10 shows a configuration example of the system consumption-resource amount transition prediction table 137. The system consumption-resource amount transition prediction table 137 manages a prediction result of a consumption resource amount transition of each unit of each device. Prediction of the consumption resource amount transition of each unit of each device is executed by the task execution program 153.

In the configuration example shown in FIG. 10, the system consumption-resource amount transition prediction table 137 includes a time column 371, a device name column 372, a unit name column 373, a type column 374, and a consumption resource amount column 375. Each record indicates a predicted consumption resource amount of one resource type of one unit in one device in one time zone. Each predicted consumption resource amount is a sum of predicted consumption resource amounts of all the tasks using the resource.

The time column 371 indicates a start time of each time zone in time series. A length of the time zone may be constant, for example. A time is represented by a day and the time. The device name column 372 indicates a name of the device to identify the device, and the unit name column 373 indicates a name of the unit to identify the unit in each device. The type column 374 indicates a type of the consumption resource of the unit. The consumption resource amount column 375 indicates a predicted consumption resource amount.

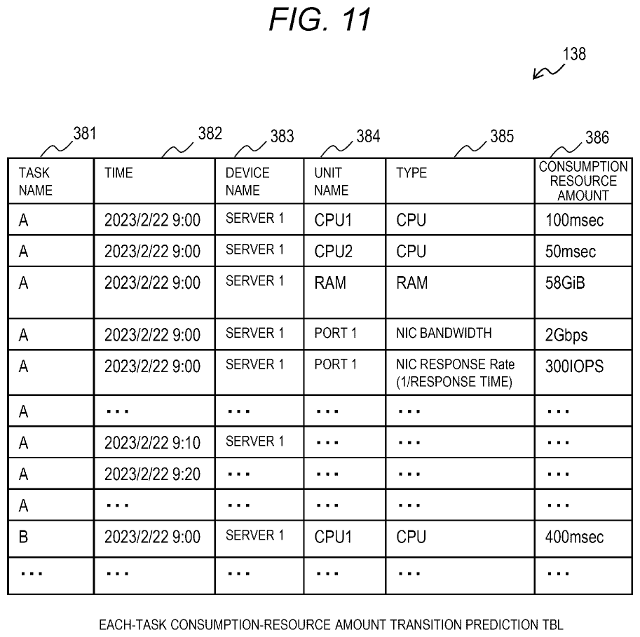

FIG. 11 shows a configuration example of the each-task consumption-resource amount transition prediction table 138. The each-task consumption-resource amount transition prediction table 138 manages a prediction result of the consumption resource amount transition of each unit of each device for each task. Prediction of the consumption resource amount transition of each unit of each device of each task is executed by the task execution program 153.

In the configuration example shown in FIG. 11, the each-task consumption-resource amount transition prediction table 138 includes a task name column 381, a time column 382, a device name column 383, a unit name column 384, a type column 385, and a consumption resource amount column 386. Each record indicates a predicted consumption resource amount of one resource type of one unit in one device in one time zone by a specified task.

The time column 382 indicates a start time of each time zone in the time series. A length of the time zone may be constant, for example. The device name column 383 indicates a name of the device to identify the device, and the unit name column 384 indicates a name of the unit to identify the unit in each device. The type column 385 indicates a type of the consumption resource of the unit. The consumption resource amount column 386 indicates a predicted resource consumption amount.

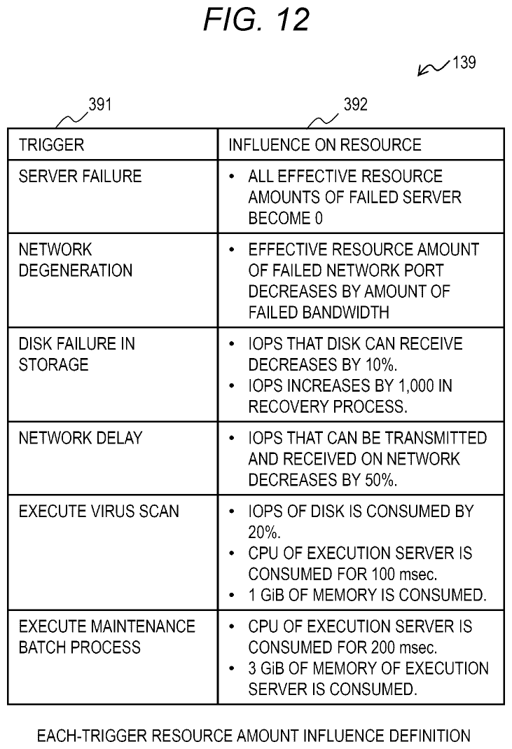

FIG. 12 shows a configuration example of the each-trigger resource amount influence definition table 139. The each-trigger resource amount influence definition table 139 defines a disturbance that is specifiable (assumed) and an influence of the disturbance on the resource. In the configuration example of FIG. 12, the each-trigger resource amount influence definition table 139 includes a trigger column 391 and an influence on the resource column 392. The trigger column 391 indicates a trigger of the specifiable disturbance. The influence on the resource column 392 indicates an influence on the resource caused by the disturbance of each trigger.

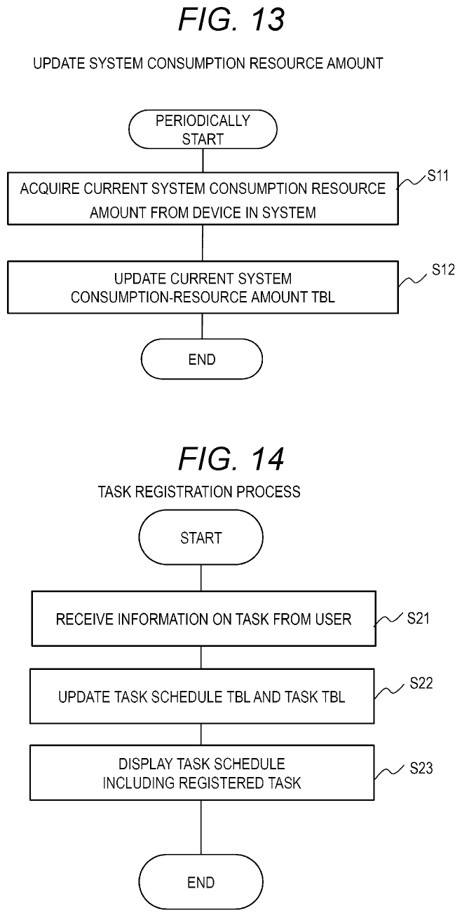

FIG. 13 shows a flowchart of a process of updating the system consumption resource amount. In this process, for example, the information on the current consumption resource amount in the system is updated periodically. Specifically, the system consumption resource amount update program 151 acquires the current system consumption resource amount from each device in the system (S11). The information can be acquired from the agent program of each device. The system consumption resource amount update program 151 updates the current system consumption-resource amount table 134 based on the acquired information (S12).

FIG. 14 is a flowchart of a task registration process. The task registration process generates a task schedule according to an input of the user. The task registration program 152 receives information on the task input by the user via the management client 30 (S21). The task registration program 152 updates the task schedule table 131 and the task table 132 according to the input of the user (S22). The information on the task provided by the user may include information different from information stored in the tables 131 and 132.

The task schedule may be specified by the user. The user determines an optimum schedule in consideration of resources possessed by the system in advance to avoid the resource shortage and complete the task within the target time. Alternatively, the task registration program 152 may generate the task schedule based on the information on the task input by the user. The task registration program 152 displays the task schedule including a registered task on the display device of the management client 30 (S23).

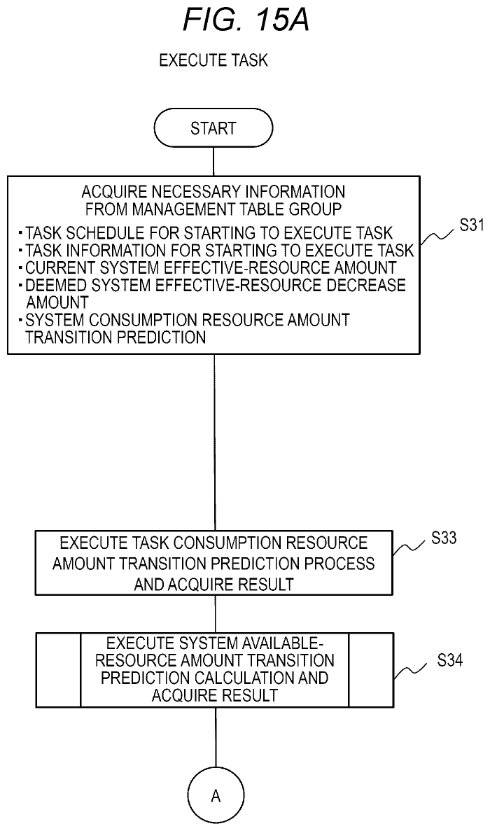

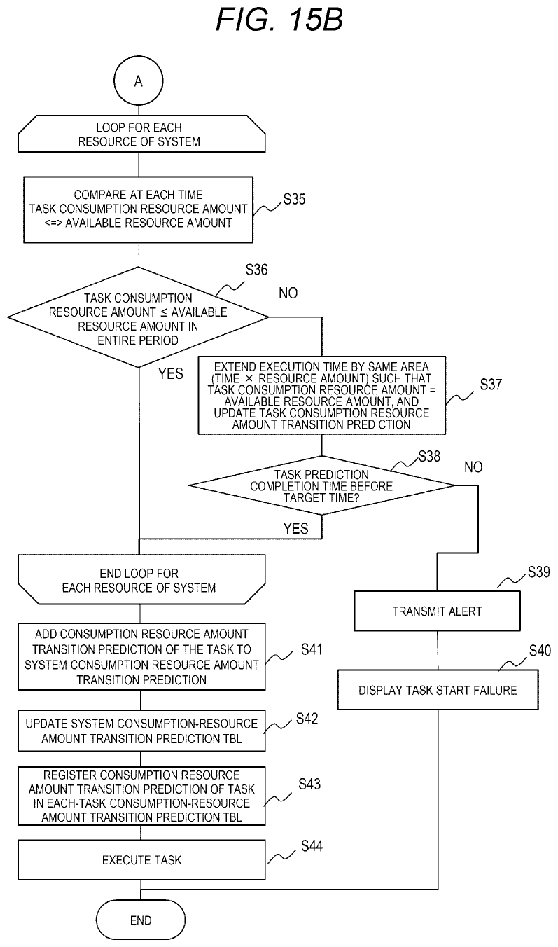

FIGS. 15A and 15B are flowcharts of a task execution process. The management server 10 starts the task according to the task schedule indicated by the task schedule table 131. When a new task starts, one or more tasks may have already been executed, or none of the tasks may have been executed.

First, the task execution program 153 acquires information necessary for executing the new task from the management table group 130 (S31). Specifically, the task schedule for starting to execute the task, task information for starting to execute the task, a current system effective-resource amount, a deemed system effective-resource decrease amount, and a system consumption resource amount transition prediction are acquired. These can be acquired from the task schedule table 131, the task table 132, the current system effective-resource amount table 133, the deemed system effective-resource decrease-amount table 135, and the system consumption-resource amount transition prediction table 137.

Next, the task execution program 153 executes a task consumption resource amount transition prediction process and acquires a result thereof (S33). The task consumption resource amount transition prediction process can be implemented by a general method. For example, the task execution program 153 predicts a consumption resource amount transition of the executed task based on information on the executed task and an execution history of various tasks in the past. Information on the executed task and the execution history in the past may be given by the user or stored in the management table group in advance.

Next, the task execution program 153 executes a system available-resource amount transition prediction calculation and acquires a result thereof (S34). An available-resource amount transition may be predicted based on the system effective-resource amount and the consumption resource amount transition of the task.

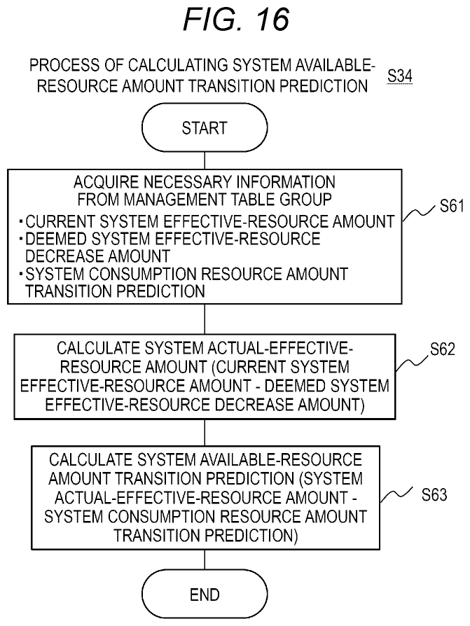

FIG. 16 shows a flowchart of a process of calculating a system available-resource amount transition prediction. The task execution program 153 acquires the necessary information from the management table group (S61). Specifically, information on the current system effective-resource amount, the deemed system effective-resource decrease amount, and the system consumption resource amount transition prediction is acquired. These can be acquired from the current system effective-resource amount table 133, the deemed system effective-resource decrease-amount table 135, and the system consumption-resource amount transition prediction table 137.

Next, the task execution program 153 calculates a system actual-effective-resource amount (S62). The actual effective-resource amount can be calculated according to the following formula.

System actual-effective-resource amount=current system effective-resource amount−deemed system effective-resource decrease amount

Next, the task execution program 153 calculates a system available-resource amount transition prediction (S63). The system available-resource e amount transition prediction can be calculated according to the following formula.

System available-resource amount transition prediction=system actual-effective-resource amount−system consumption resource amount transition prediction

Returning to FIG. 15A, a processing flow proceeds to steps in FIG. 15B via a connector A. Referring to FIG. 15B, the task execution program 153 executes steps S35 to S38 for each resource of the system.

In step S35, the task execution program 153 compares the consumption resource amount of the executed task with the available resource amount of the system for a selected resource at each time in a period in which a transition of a resource amount is predicted. When the consumption resource amount of the executed task is equal to or less than the available resource amount in the entire period (S36: YES), a loop for the selected resource is ended.

If the consumption resource amount of the executed task is larger than the available resource amount at any time (S36: NO), the task execution program 153 extends an execution time of the task by the same area (time×resource amount) such that the task consumption resource amount=the available resource amount, and updates the task consumption resource amount transition prediction (S37). That is, the extending is performed by multiplying a value of (the task consumption resource amount/the system available-resource amount) by a remaining time before the target completion time of the task. Among them, a longest extension result indicates a task prediction completion time.

Next, the task execution program 153 determines whether the task is completed by the target completion time. That is, the task execution program 153 determines whether the prediction completion time of the task is before the target completion time (S38). When the prediction completion time exceeds the target completion time (S38: NO), the task execution program 153 uses the client interface program 156 to transmit the alert to the management client 30 (S39) and display a failure to start the task execution on the management client 30 (S40).

When the task consumption resource amount in the entire period is equal to or less than the available resource amount for all the resources, the flow exits the loop and proceeds to step S41. In step S41, the task execution program 153 adds the consumption resource amount transition prediction of the task to the system consumption resource amount transition prediction.

Next, the task execution program 153 updates the system consumption-resource amount transition prediction table 137 (S42). Further, the task execution program 153 registers the consumption resource amount transition prediction of the task in the each-task consumption-resource amount transition prediction table 138 (S43). Thereafter, the task execution program 153 instructs the agent program to start the execution of the task (S44).

As described above, by executing the task consumption resource amount transition prediction based on the actual effective-resource amount corrected by the effective resource amount based on the information on the deemed system effective-resource decrease amount, it is possible to more accurately predict whether a pre-start task can be completed by the target completion time.

Next, a process associated with detection of the non-assumed disturbance will be described. The occurrence of the disturbance may influence the resource amount in the system. Further, as the disturbance that may influence the resource of the system, in addition to the specifiable type of disturbance that is assumed in advance, there are some types of disturbances that are non-assumed and cannot be specified. Hereinafter, a process of detecting the occurrence disturbance and determining influences on the system resource and the task schedule will be described.

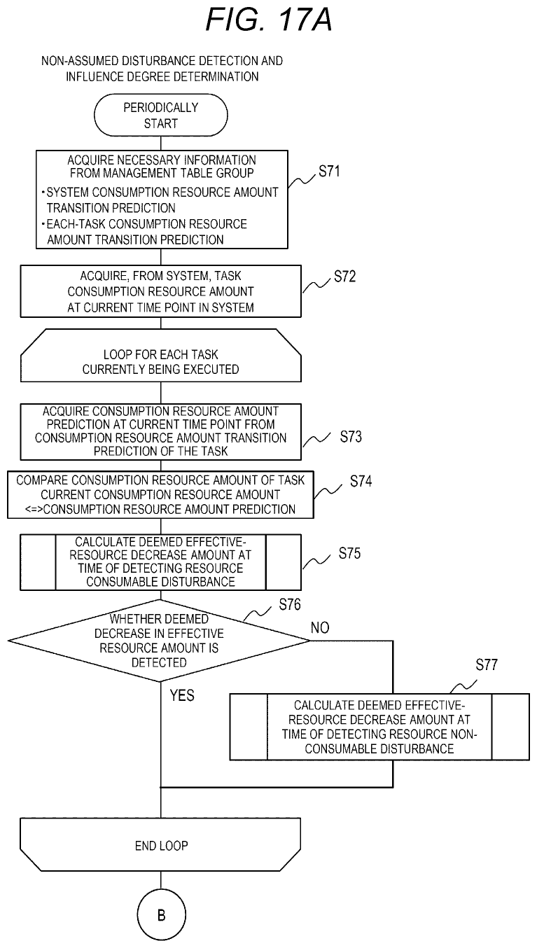

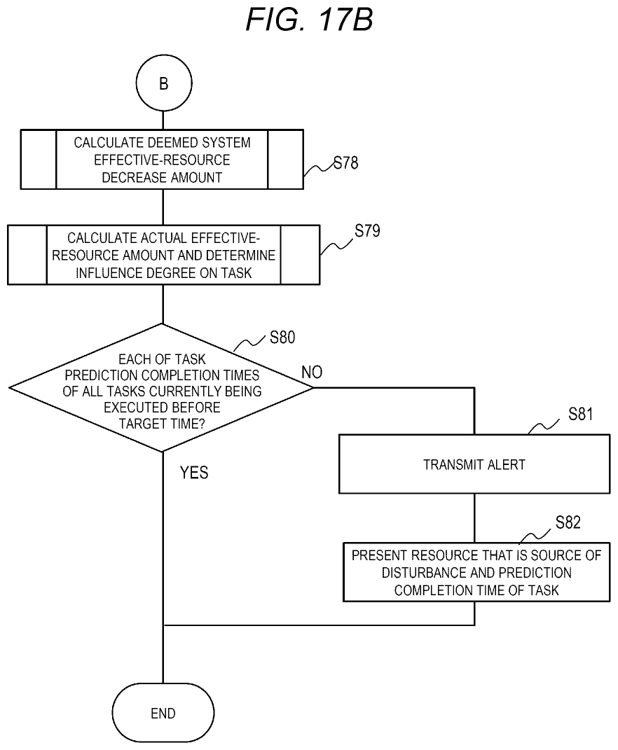

FIGS. 17A and 17B are flowcharts of the process of detecting the occurrence of the non-assumed disturbance and determining an influence degree. This process is executed periodically, for example. The non-assumed disturbance detection and influence degree determination program 154 acquires the necessary information from the management table group 130 (S71). Specifically, information on the system consumption resource amount transition prediction and the each-task consumption resource amount transition prediction is acquired. These can be acquired from the system consumption-resource amount transition prediction table 137 and the each-task consumption-resource amount transition prediction table 138.

Next, the non-assumed disturbance detection and influence degree determination program 154 acquires, from the system, the task consumption resource amount at a current time point in the system via the agent programs 41 and 51 (S72).

Next, the non-assumed disturbance detection and influence degree determination program 154 executes steps S73 to S77 for each task currently being executed.

First, the non-assumed disturbance detection and influence degree determination program 154 acquires a consumption resource amount prediction at the current time point from a consumption resource amount transition prediction of a selected task (S73). Next, the non-assumed disturbance detection and influence degree determination program 154 compares the current consumption resource amount of the task acquired from the system with the consumption resource amount prediction at the current time point for the task (S74).

The non-assumed disturbance detection and influence degree determination program 154 calculates, based on a comparison result thereof, a deemed effective-resource decrease amount at the time of detecting a resource consumable disturbance (S75). More specifically, the following process is executed.

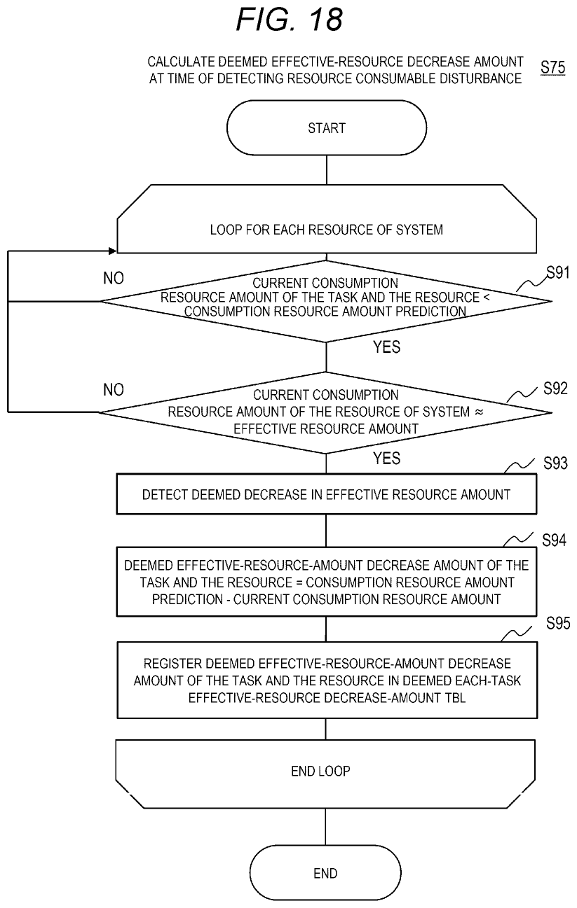

FIG. 18 shows a flowchart of a process of calculating the deemed effective-resource decrease amount at the time of detecting the resource consumable disturbance (S75). The non-assumed disturbance detection and influence degree determination program 154 executes steps S91 to S95 for each resource of the system. The non-assumed disturbance detection and influence degree determination program 154 calculates a deemed effective-resource-amount decrease amount a for resources satisfying predetermined condition.

The non-assumed disturbance detection and influence degree determination program 154 compares the current consumption resource amount of the resource for the task with the consumption resource amount prediction at the current time point of the resource for the task (S91). When the current consumption resource amount is equal to or more than the consumption resource amount prediction at the current time point (S91: NO), a next resource is selected, and step S91 is executed.

When amount is current consumption resource smaller than the consumption resource amount prediction at the current time point (S91: YES), the non-assumed disturbance detection and influence degree determination program 154 compares the current consumption resource amount of the resource of the system with the effective resource amount of the resource. Here, the non-assumed disturbance detection and influence degree determination program 154 determines whether a difference (available resource amount) between the current consumption resource amount of the resource of the system and the effective resource amount of the resource is equal to or less than a predetermined threshold value and substantially the same as the predetermined threshold value (the available resource amount is substantially zero) (S92). The threshold value may be 0 or a number larger than 0.

When a value obtained by subtracting the current consumption resource amount of the resource from the effective resource amount of the resource exceeds the threshold value (S92: NO), the next resource is selected, and step S91 is executed. When the current consumption resource amount of the resource and the effective resource amount of the resource are substantially the same (S92: YES), the non-assumed disturbance detection and influence degree determination program 154 determines that a deemed decrease in the effective resource amount is detected (S93). That is, it is determined that some kind of disturbance has occurred and a decrease in the effective resource amount not reflected in management information has occurred.

Next, the non-assumed disturbance detection and influence degree determination program 154 calculates the deemed effective-resource-amount decrease amount of the task and the resource (S94). The deemed effective-resource-amount decrease amount can be calculated by the following formula.

Deemed effective-resource-amount decrease amount=consumption resource amount prediction−current consumption resource amount

The consumption resource amount prediction and the current consumption resource amount are both values of the task and the resource.

Further, the non-assumed disturbance detection and influence degree determination program 154 registers (updates) the deemed effective-resource-amount decrease amount of the task and the resource in the deemed each-task effective-resource decrease-amount table 136.

Returning to FIG. 17A, the non-assumed disturbance detection and influence degree determination program 154 determines whether the deemed decrease in the effective resource amount is detected in step S75 (S76). When the deemed decrease in the effective resource amount is detected (S76: YES), this loop for the task is ended, and a next task is selected. When the deemed decrease in the effective resource amount is not detected (S76: NO), the non-assumed disturbance detection and influence degree determination program 154 executes a calculation of the deemed effective-resource decrease amount at the time of detecting the resource non-consumable disturbance (S77). More specifically, the following process is executed.

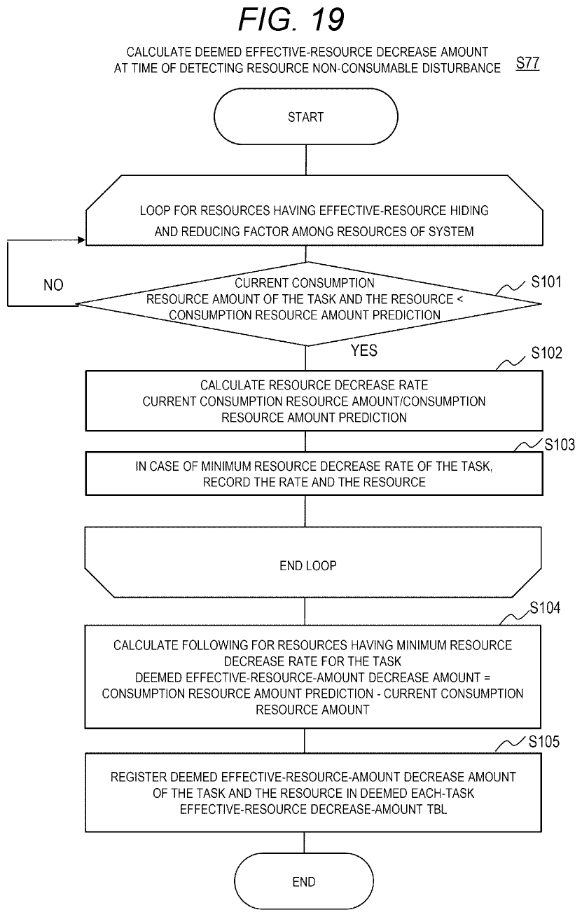

FIG. 19 shows a flowchart of a process of calculating the deemed effective-resource decrease amount at the time of detecting the resource non-consumable disturbance (S77). The non-assumed disturbance detection and influence degree determination program 154 executes steps S101 to S103 for each resource having the effective-resource hiding and reducing factor among the resources of the system. A type of the resource having the effective-resource hiding and reducing factor is set in advance. The resource having the effective-resource hiding and reducing factor is a resource of which an effective resource amount cannot be used up due to the various factors such as a communication route and a status of a communication destination. The non-assumed disturbance detection and influence degree determination program 154 calculates the deemed effective-resource-amount decrease amount for the resources satisfying the predetermined condition.

The non-assumed disturbance detection and influence degree determination program 154 compares the current consumption resource amount of the task and the resource with the consumption resource amount prediction at the current time point of the task and the resource (S101). When the current consumption resource amount is equal to or greater than the consumption resource amount prediction (S101: NO), a next resource having the effective-resource hiding and reducing factor is selected, and step S101 is executed.

When the current consumption resource amount is less than the consumption resource amount prediction (S101: YES), the non-assumed disturbance detection and influence degree determination program 154 calculates a resource decrease rate (S102). The resource decrease rate can be calculated by the following formula.

Resource decrease rate=current consumption resource amount/consumption resource amount prediction

Next, when the calculated resource decrease rate is a minimum resource decrease rate of the task, the non-assumed disturbance detection and influence degree determination program 154 records the resource decrease rate and the resource in the management information (S103).

When steps S101 to S103 are executed for all resources having the effective-resource hiding and reducing factor, the non-assumed disturbance detection and influence degree determination program 154 calculates the deemed effective-resource-amount decrease amount of the task (S104). Specifically, the non-assumed disturbance detection and influence degree determination program 154 executes the following calculation formula for the resource having the effective-resource hiding and reducing factor, which has the minimum resource decrease rate for the task.

Deemed effective-resource-amount decrease amount=consumption resource amount prediction−current consumption resource amount

Next, the non-assumed disturbance detection and influence degree determination program 154 registers (updates) the deemed effective-resource-amount decrease amount of the task and the resource in the deemed each-task effective-resource decrease-amount table 136.

Returning to FIG. 17A, when steps S73 to S77 are executed for all the tasks currently being executed, a processing flow proceeds to step in FIG. 17B via a connector B. Referring to FIG. 17B, the non-assumed disturbance detection and influence degree determination program 154 calculates the deemed system effective-resource decrease amount (S78). More specifically, the following process is executed.

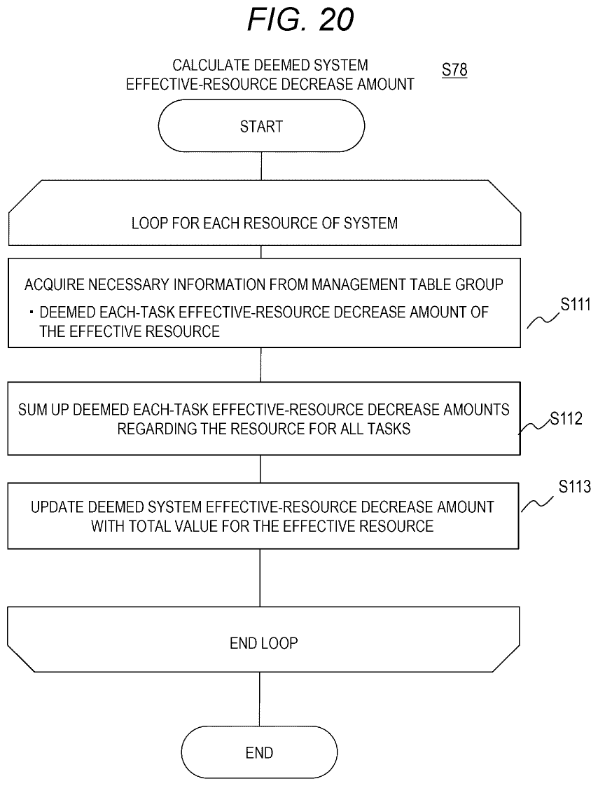

FIG. 20 shows a flowchart of a process of calculating the deemed system effective-resource decrease amount (S78). The non-assumed disturbance detection and influence degree determination program 154 executes steps S111 to S113 for each resource of the system.

First, the non-assumed disturbance detection and influence degree determination program 154 acquires the necessary information from the management table group 130 (S111). Specifically, the information on the deemed each-task effective-resource decrease amount of the effective resource is acquired from the deemed each-task effective-resource decrease-amount table 136.

Next, the non-assumed disturbance detection and influence degree determination program 154 sums up deemed each-task effective-resource decrease amounts regarding the resource for all the tasks (S112). Next, the non-assumed disturbance detection and influence degree determination program 154 updates the deemed each-task effective-resource decrease-amount table 136 with a total value for the effective resource (S113).

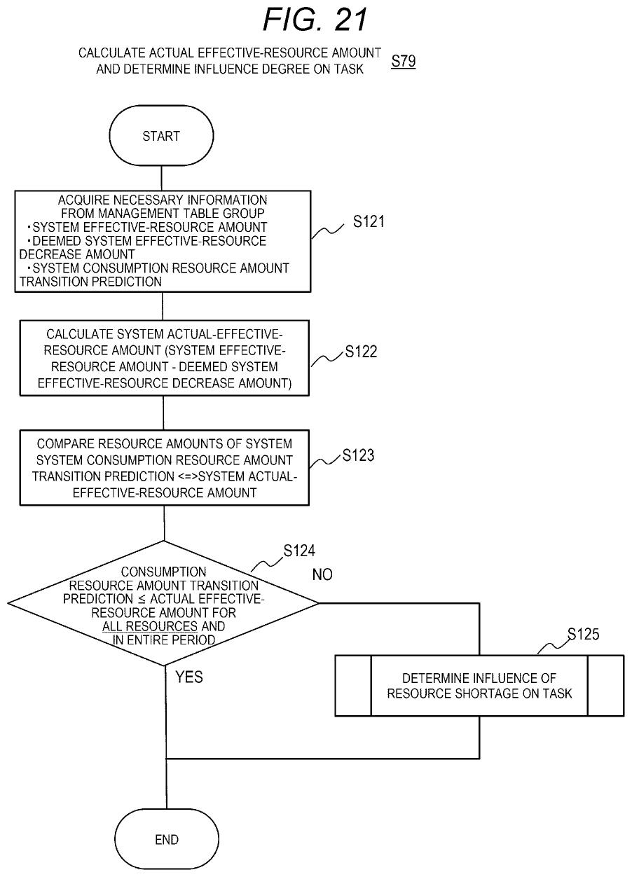

Returning to FIG. 17B, the non-assumed disturbance detection and influence degree determination program 154 executes the calculation of the actual effective-resource amount and the influence degree determination of the task (S79). More specifically, the following process is executed. FIG. 21 shows a flowchart of a process of calculating the actual effective-resource amount and determining an influence degree on the task (S79).

First, the non-assumed disturbance detection and influence degree determination program 154 acquires the necessary information from the management table group 130 (S121). Specifically, the information on the system effective-resource amount, the deemed system effective-resource decrease amount, and the system consumption resource amount transition prediction is acquired. These can be acquired from the current system effective-resource amount table 133, the deemed system effective-resource decrease-amount table 135, and the system consumption-resource amount transition prediction table 137.

Next, the non-assumed disturbance detection and influence degree determination program 154 calculates the actual effective-resource amount for each resource of the system (S122). The actual effective-resource amount can be calculated according to the following formula.

System actual-effective-resource amount=system effective-resource amount−deemed system effective-resource decrease amount

Next, the non-assumed disturbance detection and influence degree determination program 154 compares resource amounts of the respective resources of the system (S123). Specifically, the system consumption resource amount transition prediction is compared with the system actual-effective-resource amount.

For all the resources, if a condition of the consumption resource amount transition prediction≤the system actual-effective-resource amount is satisfied during the entire period (S124: YES), this processing flow ends. When this condition is not satisfied (S124: NO), the non-assumed disturbance detection and influence degree determination program 154 determines the influence of the resource shortage on the task (S125). Specifically, the following process is executed.

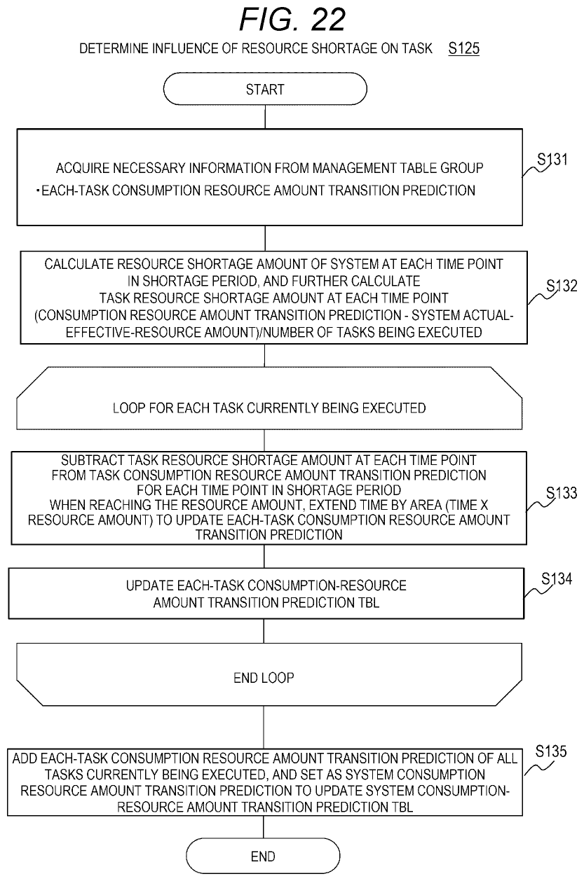

FIG. 22 shows a flowchart of a resource shortage influence determination process of the task (S125). The process shown in FIG. 22 is executed for each resource of the system. First, the non-assumed disturbance detection and influence degree determination program 154 acquires the necessary information from the management table group 130 (S131). Specifically, the information on the each-task consumption resource amount transition prediction is acquired from the each-task consumption-resource amount transition prediction table 138. The information on the system effective-resource amount, the deemed system effective-resource decrease amount, and the system consumption resource amount transition prediction has already been acquired.

Next, the non-assumed disturbance detection and influence degree determination program 154 calculates a resource shortage amount of the system at each time point of a shortage period, and further calculates a task resource shortage amount at each time point (S132). The shortage period is a period in which the system consumption resource amount transition prediction is larger than the system actual-effective-resource amount. The task resource shortage amount can be calculated according to the following formula.

Task resource shortage amount=(system consumption resource amount transition prediction−system actual-effective-resource amount)/the number of tasks which are being executed

Next, the non-assumed disturbance detection and influence degree determination program 154 executes steps S133 and S134 for each task currently being executed. First, the non-assumed disturbance detection and influence degree determination program 154 subtracts the task resource shortage amount at each time point from the task consumption resource amount transition prediction for each time point in the shortage period. When the task consumption resource amount reaches the resource amount, the execution time of the task is extended by the same area (time×resource amount) to update the each-task consumption resource amount transition prediction (S133). That is, the extending is performed by multiplying the value of (the task consumption resource amount/the system available-resource amount) by the remaining time before the target completion time of the task. Among them, the longest extension result indicates the task prediction completion time.

Next, the non-assumed disturbance detection and influence degree determination program 154 updates the each-task consumption-resource amount transition prediction table 138 according to the updated each-task consumption resource amount transition prediction (S134). When steps S133 and S134 are executed for all the tasks currently being executed, the processing flow proceeds to step S135.

In step S135, the non-assumed disturbance detection and influence degree determination program 154 adds the each-task consumption resource amount transition prediction of all the tasks currently being executed, and sets the value as the system consumption resource amount transition prediction. Further, the system consumption-resource amount transition prediction table 137 is updated according to the value (S135).

Returning to FIG. 17B, the non-assumed disturbance detection and influence degree determination program 154 compares the task prediction completion time with the task target completion time for all the tasks currently being executed (S80). When each of the prediction completion times of all the tasks currently being executed is before the target completion time (S80: YES), the processing flow ends. When the prediction completion time of any task is later than the target completion time, the non-assumed disturbance detection and influence degree determination program 154 uses the client interface program 156 to transmit the alert to the management client 30 (S81), and presents the resource that is the source of the disturbance and the prediction completion time of the task to the management client 30 (S82).

Next, a process of detecting the occurrence of the disturbance assumed in advance and determining the influence on the system resource and the task schedule will be described. In addition to processing the above-mentioned non-assumed disturbance, the management server 10 also detects the assumed disturbance and determines the influence degree thereof. Accordingly, it is possible to execute more appropriate task schedule management. The process regarding the assumed disturbance to be described below may be omitted.

As described above, in an embodiment of the present specification, the influence on the task execution is determined with respect to the disturbance that cannot be assumed in advance. The management server 10 monitors the consumption resource amount consumed by each task, and determines that the disturbance causing the resource shortage occurs when a current consumption resource amount of each task is less than the predicted consumption resource amount and the available resource amount substantially does not remain. In addition, a difference between the predicted consumption resource amount and the current consumption resource amount is interpreted and calculated as a decrease amount of the effective resource amount (available resource amount) (S75).

For each task, the management server 10 determines that an implicit disturbance occurs when there is no task for which the current consumption resource amount is smaller than the predicted consumption resource amount and the available resource amount is substantially zero. A resource that may undergo the implicit disturbance is the resource that has the effective-resource hiding and reducing factor. The management server 10 determines that a resource having a lowest decrease rate of the consumption resource and interprets and calculates the difference in the consumption resource amount as the decrease amount of the effective resource amount (available resource amount) (S77).

Based on an estimated value of the change in the available resource amount caused by the disturbance, the management server 10 calculates a possibility that the consumption resource amount required by the task currently being executed or executed from this time or task completion exceeds the target completion time. By considering the above two types of disturbances, it becomes possible to more appropriately estimate the influence of the disturbances on the task execution. Only one may be considered.

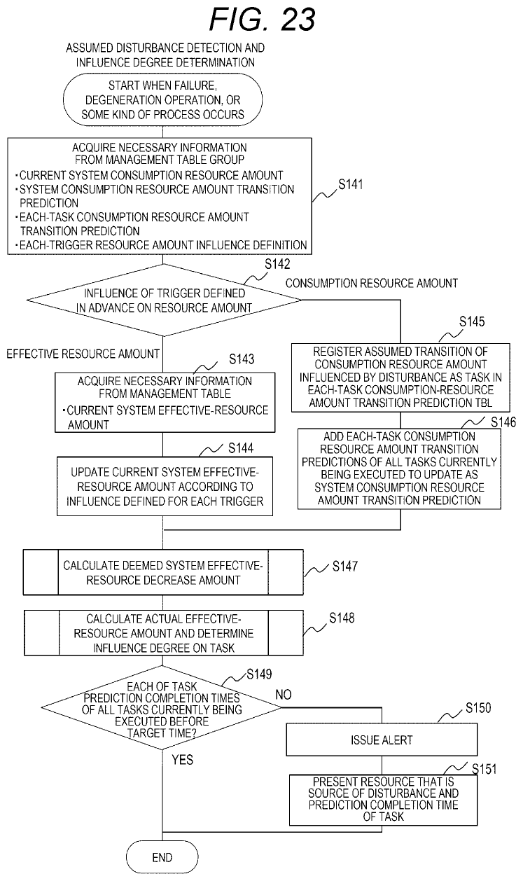

FIG. 23 shows a flowchart of a process of detecting the assumed disturbance and determining the influence degree. The process is started based on a pre-designated trigger including a specific failure such as a network delay, a software failure, or a hardware failure, or a specific process such as a maintenance process or a degeneration operation. The trigger and the influence on the resource are defined in the each-trigger resource amount influence definition table 139.

First, in response to the trigger, the assumed disturbance detection and influence degree determination program 155 acquires information necessary for the following process from the management table group 130 (S141). Specifically, the information on the current system consumption resource amount, the system consumption resource amount transition prediction, and the each-task consumption resource amount transition prediction, and the each-trigger resource amount influence definition are acquired. These can be acquired from the current system consumption-resource amount table 134, the system consumption-resource amount transition prediction table 137, the each-task consumption-resource amount transition prediction table 138, and the each-trigger resource amount influence definition table 139.

Next, the assumed disturbance detection and influence degree determination program 155 determines an influence of the trigger defined in advance on the system resource amount with reference to the each-trigger resource amount influence definition table 139 (S142). When the influence is on the effective resource amount (S142: effective resource amount), the assumed disturbance detection and influence degree determination program 155 acquires the necessary information from the management table group 130 (S143). Specifically, the information on the current system effective-resource amount is acquired from the current system effective-resource amount table 133.

Next, the assumed disturbance detection and influence degree determination program 155 updates the current system effective-resource amount according to the influence defined in the each-trigger resource amount influence definition table 139, and reflects the update in the current system consumption-resource amount table 134.

In step S142, when the influence is on the consumption resource amount (S142: consumption resource amount), the assumed disturbance detection and influence degree determination program 155 registers an assumed transition of the consumption resource amount influenced by the disturbance as the task in the each-task consumption-resource amount transition prediction table 138 (S145). Further, the assumed disturbance detection and influence degree determination program 155 adds the each-task consumption resource amount transition predictions of all the tasks currently being executed to obtain the system consumption resource amount transition prediction, thereby updating the system consumption-resource amount transition prediction table 137 (S146).

Next, the assumed disturbance detection and influence degree determination program 155 calculates the deemed system effective-resource decrease amount (S147). The deemed system effective-resource decrease amount is an effective resource amount before and after the update. A description of the non-assumed disturbance (S78) can be applied to step S147. The assumed disturbance detection and influence degree determination program 155 execute the calculation of the actual effective-resource amount and the determination of the influence degree on the task (S148). A description of the non-assumed disturbance (S79) can be applied to step S148.

Next, the assumed disturbance detection and influence degree determination program 155 determines whether the task prediction completion time is before the task target completion time for all the tasks currently being executed (S149). When all the tasks predicted to be completed by the task target completion time (S149: YES), the processing flow ends.

When any task is predicted to be completed after the target completion time (S149: NO), the assumed disturbance detection and influence degree determination program 155 uses the client interface program 156 to transmit the alert to the management client 30 (S150), and presents the resource that is the source of the disturbance and the prediction completion time of the task at the management client 30 (S151).

As described above, in an embodiment of the present specification, a change in the available resource amount is predicted in response to the occurrence of the disturbance assumed in advance. The influence of the disturbance on the effective resource amount and the consumption resource amount is defined in advance in the each-trigger resource amount influence definition table 139. When the occurrence of the defined disturbance is monitored and the occurrence of the disturbance is detected, the current effective-resource amount and the consumption resource amount are recalculated. Accordingly, it becomes possible to more accurately predict a specific disturbance.

Hereinafter, an example of information transmitted from the management server 10 and displayed in the management client 30 will be described. As described above, the management server 10 registers the task schedule in accordance with the user input from the management client 30. Thereafter, when the management server 10 determines that the task is not completed by the target completion time due to the disturbance after the task execution, the management server 10 transmits the alert to the management client 30. Accordingly, the task management performed by the user can be more appropriately supported.

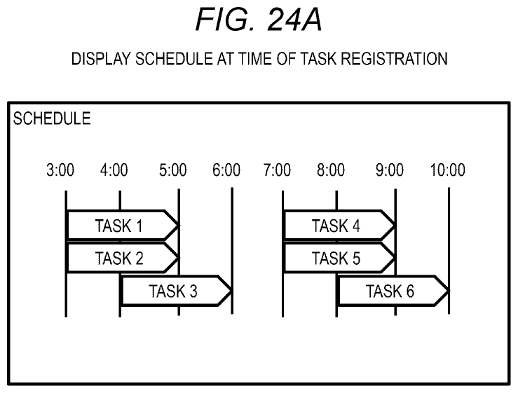

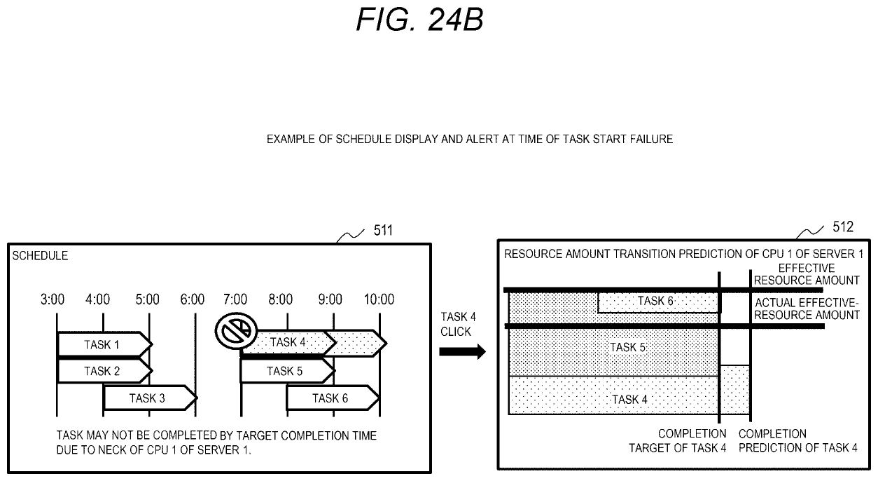

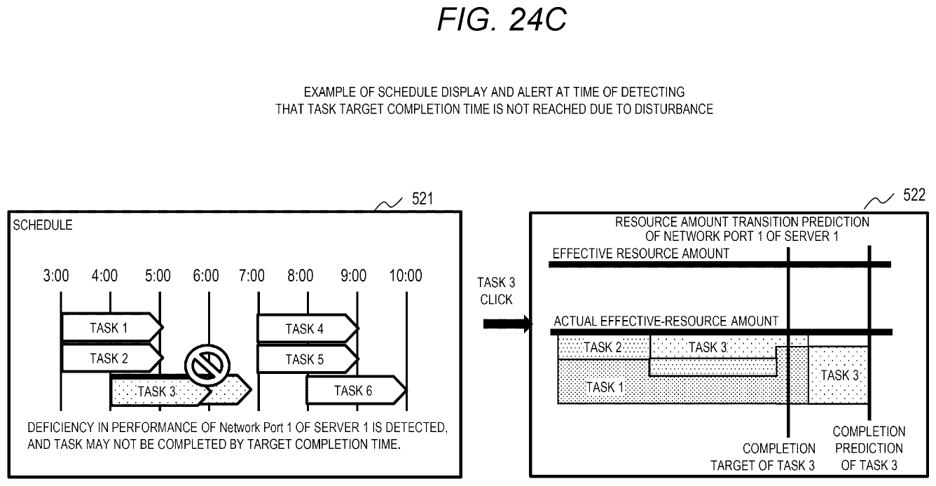

FIG. 24A shows an example of a display screen of the task schedule at the time of task registration. Each band indicates the startable time and the target completion time of each task. FIG. 24B shows an example of a display image of the task schedule and the alert when the task fails to start. In the example of FIG. 24B, a task schedule 511 and a resource amount transition prediction 512 of a CPU 1 of a server 1 are displayed. The task 4 is determined to not be completed by the target completion time.

The task schedule 511 indicates a scheduled start time and a scheduled completion time of each task by the band. Further, two bands are displayed for a task 4, and indicate a target completion time and a delayed prediction completion time, respectively.

When the task 4 is clicked (selected) in the task schedule 511, the resource amount transition prediction 512 of the CPU 1 of the server 1 is displayed. The resource amount transition prediction 512 of the CPU 1 of the server 1 indicates transition predictions of consumption resource amounts of the CPU 1 of the server 1 for tasks 4, 5, and 6. Further, effective resource, an actual effective resource, the target completion time of the task 4, and the delayed prediction completion time of the task 4 are shown.

FIG. 24C shows an example of a display image of the task schedule and the alert when the task target completion time is detected to not be reached due to the disturbance. In the example of FIG. 24C, a task schedule 521 and a resource amount transition prediction 522 of a network port 1 of the server 1 are displayed. A task 3 is determined to not be completed by the target completion time.

The task schedule 521 indicates a scheduled start time and a scheduled completion time of each task by a band. Further, two bands are displayed for the task 3, and indicate the target completion time and a delayed prediction completion time, respectively.

When the task 3 is clicked (selected) in the task schedule 521, the resource amount transition prediction 522 of the network port 1 of the server 1 is displayed. The resource amount transition prediction 522 of the network port 1 of the server 1 indicates predictions of the consumption resource amounts of the network port 1 of the server 1 for tasks 1, 2, and 3. Further, effective resource, an actual effective resource, the target completion time of the task 3, and the delayed prediction completion time of the task 3 are shown.

The invention is not limited to the above-described embodiment, and includes various modifications. For example, the embodiment described above has been described in detail to facilitate understanding of the invention, and the invention is not necessarily limited to those including all the configurations described above. A part of a configuration according to one embodiment can be replaced with a configuration according to another embodiment, and a configuration according to one embodiment can also be added to a configuration according to another embodiment. A part of the configuration of each embodiment may be added to, deleted from, or replaced with another configuration.

Some or all of the configurations, functions, processing units, and the like described above may be implemented by hardware by, for example, designing with an integrated circuit. In addition, the configurations, functions, and the like described above may be implemented by software by a processor interpreting and executing a program for implementing each function. Information such as a program, a table, and a file for implementing each function can be stored in a recording apparatus such as a memory, a hard disk, or a solid state drive (SSD), or in a recording medium such as an IC card or an SD card.

Further, control lines and information lines are those considered to be necessary for description, and not all the control lines and information lines are necessarily shown in the product. Actually, it may be considered that almost all the configurations are connected to one another.

What is claimed is:

1. A task management system that manages a plurality of tasks executed by a target system, the task management system comprising:
a processor; and
a memory, wherein
the memory is configured to store
a consumption resource amount transition prediction of a resource consumed by the plurality of tasks, and
effective resource amount information for managing an effective resource amount indicating a total resource amount that is providable from the resource, and
the processor is configured to, for the resource consumed by each of the plurality of tasks,
compare consumption resource amount prediction obtained from the consumption resource amount transition prediction with a current consumption resource amount,
determine that the effective resource amount of the resource is decreased when a predetermined condition including that the current consumption resource amount is smaller than the consumption resource amount prediction is satisfied,
estimate a decrease amount of the effective resource amount based on a difference between the current consumption resource amount and the consumption resource amount prediction, and
determine an influence on task execution based on the decrease amount.

2. The task management system according to claim 1, wherein
the predetermined condition further includes that a difference between the effective resource amount of the resource and the current consumption resource amount of the resource is less than a threshold value.

3. The task management system according to claim 1, wherein
the predetermined condition includes that the resource is a pre-designated resource and is a resource in which a ratio of the current consumption resource amount to the consumption resource amount prediction is smallest in the resource consumed by the tasks.

4. The task management system according to claim 1, wherein
the resource consumed by the plurality of tasks includes bandwidth of a network port.

5. The task management system according to claim 1, wherein
the memory is configured to further store disturbance definition information that defines an influence of a disturbance on the resource in the target system, and
the processor is configured to
detect the disturbance indicated by the disturbance definition information,
determine a change in the effective resource amount caused by the detected disturbance based on the disturbance definition information, and
determine an influence of a task, which is being executed, on a prediction completion time based on the change in the effective resource amount.

6. The task management system according to claim 1, wherein
the processor is configured to
calculate the decrease amount of the effective resource amount of the resource from a total of the decrease amounts of the effective resource amount of the plurality of tasks, and
determine whether there is a task of which a prediction completion time exceeds a target completion time based on the decrease amount of the effective resource amount of the resource and the consumption resource amount transition prediction.

7. The task management system according to claim 6, wherein
the processor is configured to present an alert to a user when there is a task of which the prediction completion time exceeds the target completion time.

8. A method for managing, with a management system, a plurality of tasks executed by a target system,
the management system storing
a consumption resource amount transition prediction of a resource consumed by the plurality of tasks, and
effective resource amount information for managing an effective resource amount indicating a total resource amount that is providable from the resource, and
the method comprising:
for the resource consumed by each of the plurality of tasks,
the management system comparing a consumption resource amount prediction obtained from the consumption resource amount transition prediction with a current consumption resource amount;
the management system determining that the effective resource amount of the resource is decreased when a predetermined condition including that the current consumption resource amount is smaller than the consumption resource amount prediction is satisfied;
the management system estimating a decrease amount of the effective resource amount based on a difference between the current consumption resource amount and the consumption resource amount prediction; and
the management system determining an influence on task execution based on the decrease amount.
